(19) United States
(12) Patent Application Publication
(10) Pub. No.: US 2009/0254844 A1
(43) Pub. Date: Oct. 8, 2009

(54) METHOD AND SYSTEM FOR MANAGING EVENT RESERVATIONS AND RESOURCE DISPATCHING

(76) Inventors: George DAVIDSON, Calgary (CA); Robert Lee CHRISTIANSON, Calgary (CA)

Correspondence Address: BENNETT JONES LLP, 3400 ONE FIRST CANADIAN PLACE, PO BOX 130, TORONTO, ON, M5X 1A4, CA

(21) Appl. No.: 12/098,101

(22) Filed: Apr. 4, 2008

(51) Int. Cl. G06F 9/46; G06F 3/048

(52) U.S. Cl. 715/764; 718/104

(57) ABSTRACT

A system and method for allocating resources to an event and/or managing the allocation of the resources. The event may comprise a ticketed event, such as, a tour, a shuttle service, an excursion, a sporting event, a concert, a play, a stage performance, or other type of performance or event, and the resources may comprise one or more ground transportation vehicles. According to an embodiment, the system comprises an interface configured to transfer event data from a reservation or ticketing system, one or more data structures for storing the event data and data for one or more resources, and a processor configured to allocate the one or more resources to the event.

### FIELD OF THE INVENTION

The present invention relates to computer systems and more particularly, to a method and system for managing event reservations or ticketing and resource allocation for the event.

### BACKGROUND OF THE INVENTION

The options for travel and touring are ever increasing. Online ticketing and reservation systems have further enhanced the offerings of events and tours. Online ticketing systems also offer a convenience to both customers and travel professionals alike in the selection and booking of a trip or excursion.

Once an excursion, for example, a tour in a foreign country, is booked, e.g. the tickets are sold, there typically comes a need to schedule one or more types of resources as part of the excursion. For example, a bus to transport the patrons from the airport to the resort, jeeps for a rainforest tour from the resort, physical and manpower resources for the excursion, etc.

While there are known reservation and ticketing systems in the art, there remains a need for improvements in the art for a system and/or method which can interface with a reservation or ticketing system and manage the allocation of resources associated with an event, such as a tour or excursion.

### SUMMARY OF THE INVENTION

The present invention provides a method and system for managing and/or allocating resources for an event, such as a tour, concert, sporting event, play, excursion or other type of outing or performance. According to an aspect, the event, i.e. tour or excursion, is booked utilizing an online ticketing reservation system, either in point-of-sale, telephone call centre or online booking mode.

According to one aspect, the present invention provides a system for allocating one or more resources to an event, the system comprises: an interface for transferring event data from a reservation system; a data structure for storing the event data; a data structure for storing data associated with the resources; a processor configured to allocate the one or more resources to the event based on the event data and the resources data.

According to another aspect, the present invention provides a computer-implemented method for allocating one or more resources to an event, the method comprises the steps of: obtaining event data from a reservation system; making available one or more resources for the event; and allocating the one or more resources to the event based on criteria associated with the event or the one or more resources.

According to a further aspect, the present invention provides a computer program product for allocating one or more resources to an event, the computer program product comprises: a storage medium configured to store computer readable instructions; the computer readable instructions including instructions for, obtaining event data from a reservation system; making available one or more resources for the event; and allocating said one or more resources to the event based on criteria associated with the event or the one or more resources.

According to another aspect, the present invention provides a system for allocating one or more resources to an event, the system comprises: a data transfer interface configured for transferring event data from a reservation system; a data structure configured for storing the event data; a data structure configured for storing data associated with the resources; and a user interface module comprising a screen configured to represent at least some of the event data and at least some of the resources data, and the screen being configured to be responsive to one or more user inputs for allocating the one or more resources to the event.

Other aspects and features of the present invention will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example, embodiments of the present invention, and in which:

FIG. 1 shows in diagrammatic form a system for managing bookings and dispatch of resources according to an embodiment of the present invention;

FIG. 2 shows an exemplary process flow for the system of FIG. 1 according to an embodiment of the invention;

FIG. 3 shows an exemplary data flow for the system of FIG. 1 according to an embodiment of the invention;

FIG. 4 shows an example of event information processing according to an embodiment of the present invention;

FIG. 5 shows an example of information processing in response to a ticket purchase;

FIGS. 6(a) to 6(c) are screen shots of a dispatch screen according to an embodiment of the present invention;

FIG. 7 is a screen shot of a title page for the system of FIG. 1 according to an embodiment of the invention;

FIG. 8 is a screen shot of a login screen according to an embodiment of the invention;

FIG. 9 is a screen shot of the dispatch screen of FIG. 6 configured according to an exemplary resource allocation for an event;

FIG. 10 is a screen shot of a portion of the dispatch screen in accordance with the example of FIG. 9;

FIG. 11 is another screen shot of the dispatch screen in accordance with the example of FIG. 9;

FIG. 12 is a screen shot of the lower portion of the dispatch screen in accordance with the example of FIG. 9;

FIG. 13 is another screen shot of the lower portion of the dispatch screen in accordance with the example of FIG. 9;

FIG. 14 is a screen shot of a portion of the dispatch screen in accordance with the example of FIG. 9;

FIG. 15 is another screen shot of the dispatch screen configured in accordance with the example of FIG. 9;

FIG. 16 shows in flowchart form an exemplary process for allocating resources to an event according to an embodiment of the present invention;

FIG. 17 is a screen shot of a “Driver Fees” screen according to an embodiment of the present invention;

FIG. 18 is a screen shot of a “Chain” screen according to an embodiment of the present invention;

FIG. 19 is a screen shot of a “Company” screen according to an embodiment of the present invention;

FIG. 20 is a screen shot of a “Drivers” screen according to an embodiment of the present invention;

FIG. 21 is a screen shot of an “Exchange Rate” screen according to an embodiment of the present invention;

FIG. 22 is a screen shot of a “Hotel” screen according to an embodiment of the present invention;

FIG. 23 is a screen shot of a “Pick Up Times” screen according to an embodiment of the present invention;

FIG. 24 is a screen shot of a “Location” screen according to an embodiment of the present invention;

FIG. 25 is a screen shot of a “Tour Operator” screen according to an embodiment of the present invention;

FIG. 26 shows a screen shot of a “Representatives” screen according to an embodiment of the present invention;

FIG. 27 shows a screen shot of a “Vehicle” screen according to an embodiment of the present invention; and

FIGS. 28(i) to 28(vi) show in a diagrammatic form a database structure for the system of FIG. 1 according to an embodiment of the present invention.

Like reference numerals indicate like or corresponding elements in the drawings.

### DETAILED DESCRIPTION OF THE EMBODIMENTS OF THE INVENTION

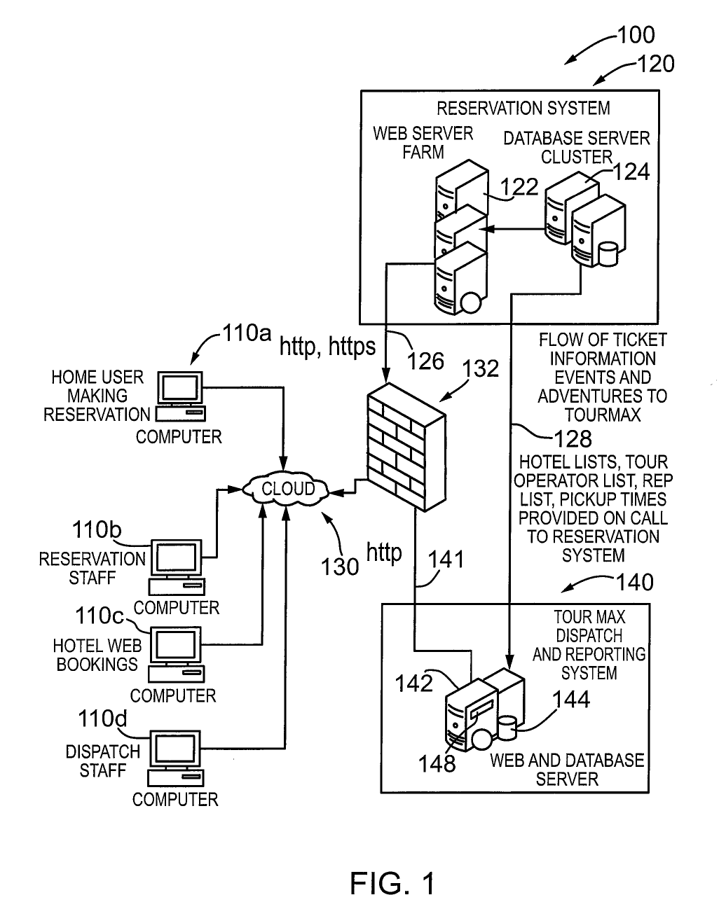

Reference is made to FIG. 1, which shows a system for managing travel reservations or ticketing and resource dispatching according to an embodiment of the invention, and indicated generally by reference 100. According to an embodiment, the system 100 comprises a client/server configuration. As shown, one or more clients 110, indicated individually by references 110a, 110b, 110c . . . 110n, access a reservation system indicated by reference 120, for example, through a network 130. The network 130 may comprise a local area network (LAN), a wide area network (WAN), the Internet or any combination thereof. As shown the reservation system 120 interfaces with an event resource allocation and management system indicated generally by reference 140. As depicted in FIG. 1, the reservation system 120 and the event resource allocation and management system 140 may be configured behind a firewall or security structure indicated generally by reference 132.

While embodiments according to the present invention are described in the context of an application directed to tour or excursion based companies, it will be appreciated that the present invention is suitable for other applications in which resources are to be allocated or managed among subscribers or participants to an event. For example, the event may comprise a concert, a transport shuttle, a sporting event, a theatrical play, performance or other type of event or planned outing.

As shown in FIG. 1, the clients 110 comprise users that would typically make a reservation. In the context of an exemplary embodiment, the clients comprise a home user 110a, e.g. for an individual booking a vacation or excursion from their home computer, a reservation staff member 110b, a hotel web site booking 110c, and/or a dispatch staff member 110d.

As shown in FIG. 1, the event resource allocation and management system 140 comprises a web server 142 and a database server 144. The web server 142 is configured with an application indicated generally by reference 148. According to an embodiment, the application 148 comprises a client interface module configured with a plurality of screens and graphical user interface (as described in more detail below) and the underlying computer program components (e.g. functions, objects, code, etc.) to provide the functionality associated with the system 140. The database server 144 comprises a data table as described in more detail below.

As depicted in FIG. 1, the reservation system 120 comprises one or more servers 122 (e.g. configured in a “Web server farm” as will be within the understanding of one skilled in the art) and one or more database servers 124 (e.g. configured in a database server cluster as will be within the understanding of one skilled in the art). The reservation system 120 may comprise an existing ticketing/reservation system as will also be within the understanding of one skilled in the art. In known manner, the reservation system 120 includes an HTTP or HTTPS interface or link to the users 110. The reservation system 120 includes an interface or link indicated generally by reference 128. The interface 128 is configured to transfer or “push” data from the reservation system 120, e.g. ticketing data, to the event resource allocation and management system 140. According to an embodiment, the data is stored in a data table 300 configured on the database server 144, as described in more detail below. The event resource allocation and management system 140 is configured with the application 148 which is configured to process data from the data table 300 for providing resource management and allocation of resources as will also be described in more detail below.

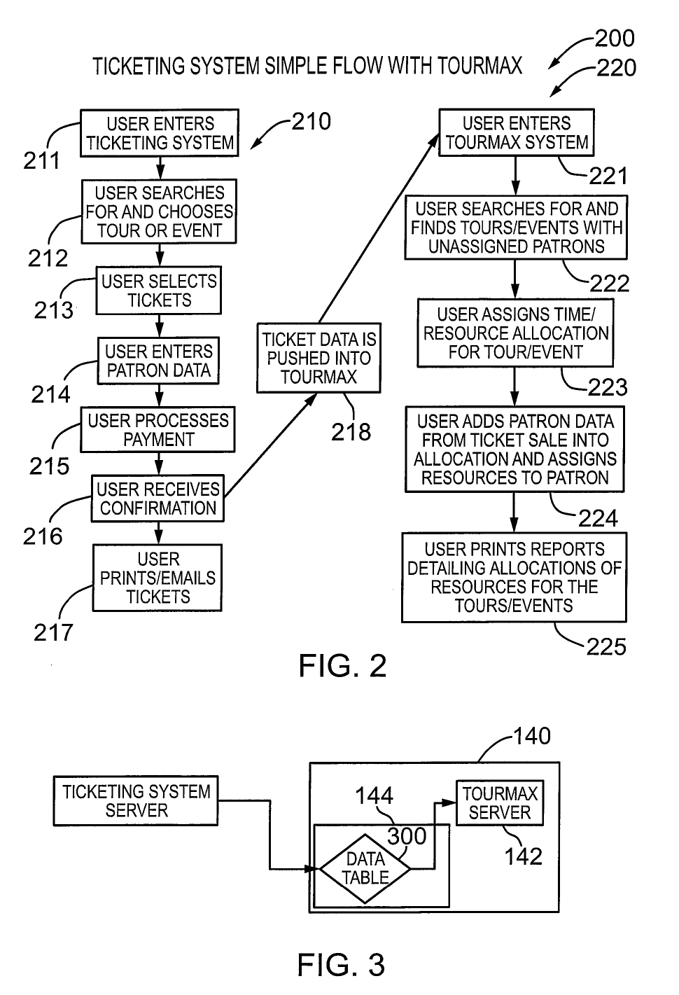

Reference is next made to FIG. 2, which shows in flowchart form an exemplary process flow for the system 100 of FIG. 1 according to an embodiment. The process flow, indicated generally by reference 200, comprises two aspects. The first aspect indicated by reference 210 comprises a user making a reservation, e.g. booking tickets for an excursion or an event. The second aspect indicated generally by reference 220 and comprises managing/allocating resource(s) associated with the event (e.g. an excursion, tour or the like).

As shown and indicated by reference 211, the user enters (e.g. logs on) to the ticketing system (e.g. reservation system 120 in FIG. 1). The user searches for and chooses an event (e.g. a tour, excursion, concert, sporting event), as indicted by reference 212, and then selects tickets for the event, as indicated by reference 213. The user enters the patron's data in step 214 and payment of the tickets is processed as indicated by reference 215. The user receives confirmation from the reservation system 120 (FIG. 1), as indicated by reference 216. The user, for example, an individual, prints the tickets at their home, or the user, for example, a travel agent, emails the ticket(s) to the customer/client, as indicated by reference 217.

The next step as shown and indicated by reference 218 in FIG. 2 comprises transferring or “pushing” the tour (e.g. ticket) data to the event resource allocation and management system 140 (FIG. 1). According to an embodiment, data transferred from the reservation management system 120 is stored in the data table 300 in the event resource allocation and management system 140 as depicted in FIG. 3.

According to an embodiment, the event resource allocation and management system 140 is configured to process data from the data table 300 and provide management/allocation of resources associated with the booked or ticketed event. As shown in FIG. 2 and indicated by reference 221, an operator or user (e.g. a tour operator) enters the event resource allocation and management system 140, for example, via an HTTP (or HTTPS) link indicated by reference 141 in FIG. 1. Next, the user uses the application to search for event(s) (e.g. tours, excursions) that have unassigned patrons (also referred to as “PAX”), as indicated by reference 222. The user then uses the application to assign a time/resource allocation for the event, as indicated by reference 223. The user retrieves data associated with the patron from the data table 300 (FIG. 3), i.e. based on the booking or ticket sale, and resources are allocated or assigned to the patron, as indicated by reference 224. According to an embodiment, the application 148 is configured to provide the user with one or more reports that detail the allocation of resources for the event, e.g. a tour, as indicated by reference 225 in FIG. 2.

According to an embodiment of the invention, there are two categories of information transferred from the reservation system 120 to the event resource allocation and management system 140. The two categories are (1) event data, and (2) patron (PAX) or sales data. According to embodiment, the following ticket or event data information is used by the event resource allocation and management system 140:

### (1) Event Data

Event Name

Event Code

Event Date/Time

Event Duration

Venue

Capacity

Cost Centre

### (2) Patron and Sales Data

Order Number

Patron Name

Number of tickets or patrons (PAX)

Cost per ticket or order total

Hotel

Hotel room Number

Tour Operator

Tour Rep (Optional)

Payment Type (Optional)

Incentive Payee (Optional)

Alternate Pickup Location (Optional)

Comments (Optional)

Voucher Number (Optional)

It will be appreciated that not all data listed above may be needed in a particular application. For example, “Tour Rep”, “Payment Type”, “Incentive Payee”, “Alternative Pickup Location”, “Comments” and/or “Voucher Number” data is listed as being optional and may not be utilized or used in all applications or embodiments.

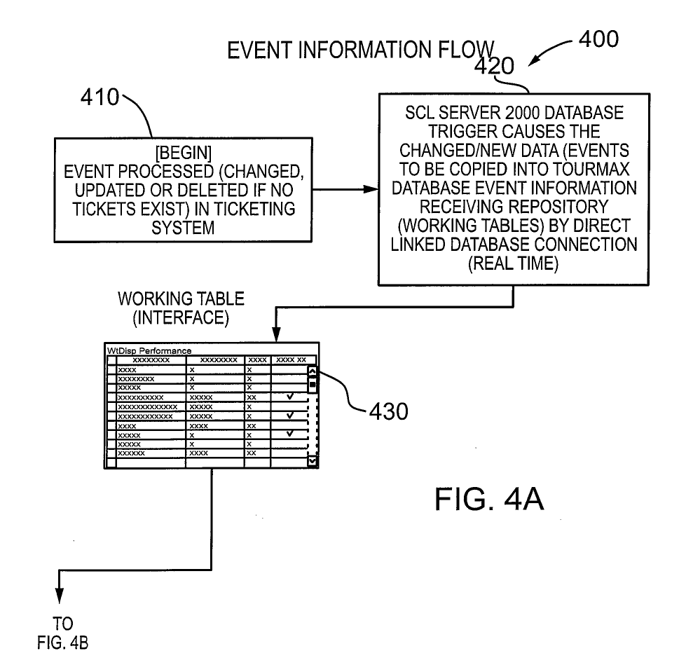

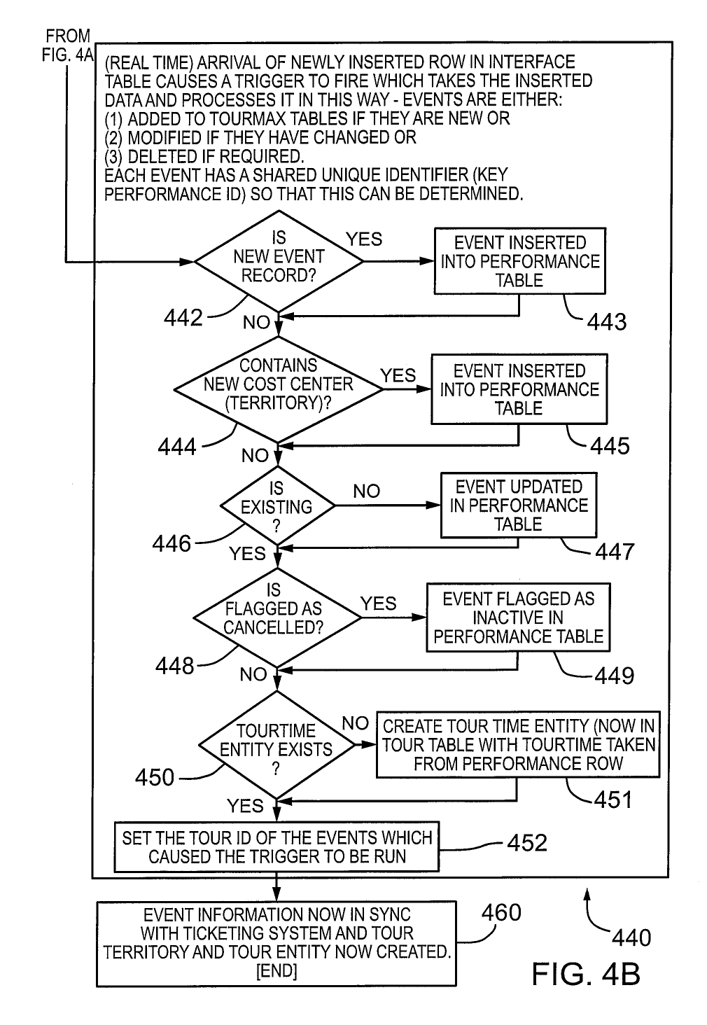

Reference is next made to FIG. 4, which shows an example of a process for transferring event data from the reservation system 120 (FIG. 1) to the event resource allocation and management system 140 (FIG. 1) according to an embodiment of the invention. The process for event information transfer or flow is indicated generally by reference 400 in FIG. 4. The process 400 begins or is initiated as indicated by reference 410, for example, in response to an event being processed by the reservation system 120. According to an embodiment, the process 400 is initiated in response to a trigger event occurring in the database server 124 (FIG. 1) for the reservation system 120. For example, if the database server 124 comprises a SQL server implementation, then a SQL trigger, for example, tickets purchased or issued, tickets changed, tickets updated, or tickets deleted, for an event or a patron, is generated or issued. The trigger causes data to be transferred, e.g. copied, from the database server 124 to the event resource allocation and management system 140 via the link 128 (FIG. 1), as indicated by reference 420. According to an embodiment, the event resource allocation and management system 140 (i.e. the application 148 (FIG. 1)) is configured with a working table (i.e. data structure) indicated by reference 430. The working table 430 provides a data interface between the reservation system 120 and the event resource allocation and management system 140. According to an embodiment, the working table 430 is configured to store event data and patron (PAX) data (as described above) in rows and comprises a ‘Name’ column, a ‘Data Type’ column, a ‘Data Length’ column, and an ‘Allow Nulls’ column.

Referring still to FIG. 4, the event resource allocation and management system 140 (i.e. the application 148) is configured to execute a process (e.g. an algorithm) to extract data from the working table 430, as indicated by reference 440. According to an embodiment, the data extracted and/or processed from the working table 430 is stored in the data table 300, as described above. According to an embodiment, the process 440 is triggered (in real time) by the insertion of a new row of data in the working table 430. In response, the process 440 is configured to add new data to the data table 300, modify data in the data table 300 and/or delete data in the data table 300, as will be described in more detail below.

As shown, the process 440 determines if the change to the working table 430 comprises a new “Event” record, as indicated by decision block 442. If yes or True, then the event data is inserted into the data table 300, as indicated by reference 443. Next a check is made in decision block 444 to determine if the change in the working table 430 comprises data for a new “Cost Center” or “Territory”, as indicated by decision block 444. If yes, then the event data is inserted into the data table 300, as indicated by reference 445. Next, a check is made in decision block 446 to determine if the change involves existing data in the table. If no or False, then the event data is updated in the data table 300, as indicated by reference 447. Next, a check is made in decision block 448 to determine if the change comprises data flagged or marked as cancelled. If yes, then the flagged data is marked or designated as inactive in the data table 300, as indicated by reference 449. Next, a check is made in decision block 450 to determine if a “Tour Time Entity” exists. If no, then the application is configured to create a “Tour Time Entity” in the data table, e.g. a row in the data table 300 populated with data taken from the working table 430, as indicated by reference 451. Next and as indicated in block 452, the process 440 is configured to set a “TourID” parameter for the event that caused the trigger. According to an embodiment, the process 440 ends with information (e.g. the Tour Territory and the Tour Entity) in the data table 300 being synchronized, i.e. in sync, with the event information in the reservation system 120, as indicated in block 460.

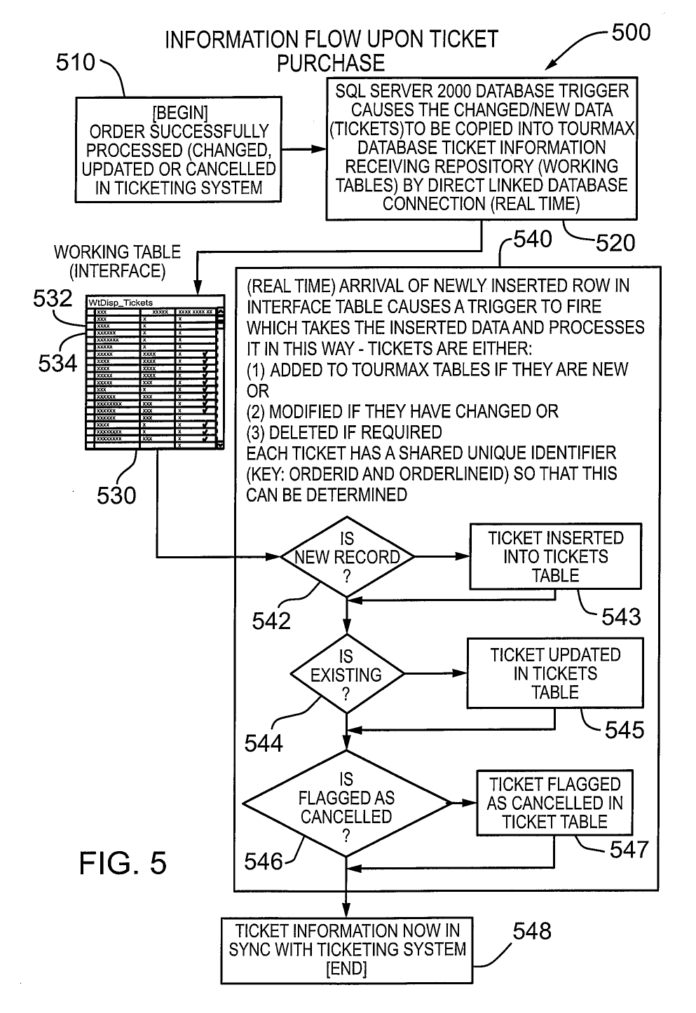

Reference is next made to FIG. 5, which shows the process for transferring event data from the reservation system 120 (FIG. 1) to the event resource allocation and management system 140 (FIG. 1) for an exemplary ticket purchase transaction. The process is indicated generally by reference 500 and implemented or configured in the application 148 to function in a manner similar to that described above for the process 400. It will be appreciated that the configuration of the working data table 530, i.e. the number and/or types of fields, can be modified according to the particular application, i.e. type of event, tour, excursion, concert, sporting event, theatrical play, etc.

As shown in FIG. 5, the process for transferring ticket purchase data 500 begins with a ticket purchase being processed by the ticketing system 120 (FIG. 1) as indicated by reference 510. In the context of the present example, the reservation system 120 of FIG. 1 is referred to and comprises a “ticketing system” 120, and the data table 300 (FIG. 3) is referred to as a “ticket table”. According to an embodiment, the process 500 is initiated in response to a trigger event occurring in the database server 124 (FIG. 1) for the ticketing system 120. For example, where the database server 124 comprises a SQL server implementation, then a SQL trigger, for example, in response to tickets being purchased or issued or changed, is generated or issued. The trigger causes data to be transferred, e.g. copied, from the database server 124 to the event resource allocation and management system 140 via the link 128 (FIG. 1), as indicated by reference 520, via a working or interface table (i.e. data structure) indicated by reference 530. As described above, the working table 530 provides a data interface between the ticketing system 120 and the event resource allocation and management system 140. According to an embodiment, the working table 530 is configured to store ticket purchase data and patron (PAX) data (as described above) in rows and comprises a ‘Name’ column, a ‘Data Type’ column, a ‘Data Length’ column, and an ‘Allow Nulls’ column. According to an embodiment, each ticket is identified according to an “OrderID” in row 532 and an “OrderLineID” in row 534.

Referring to FIG. 5, the insertion of new data into the interface table 530 causes the application 148 (FIG. 1) to execute a process for extracting ticket information from the working table 530. The process for extracting ticket information is indicated generally by reference 540 and configured in the application 148 in the form of one or more functions and/or software objects to provide the following functionality: (1) if the ticket purchase is new, the ticket information is added to the ticket table 300 (FIG. 1) in the database server 144; (2) if the tickets have been changed, then the ticket information in the ticket table 300 is modified in accordance with the change; or (3) if ticket(s) have been cancelled, then the corresponding ticket information is deleted from the ticket table 300.

As shown in FIG. 5, the process for extracting ticket information 540 comprises first determining if the ticket data comprises a new record, as indicated by decision step 542. If yes, then the ticket data is inserted in the ticket table (i.e. the data table 300). If the ticket data is not new, then the process 540 determines if the ticket data inserted into the working table 530 is associated with an existing ticket record, as indicated by decision step 544. If yes, then the corresponding ticket record in the ticket table 300 is updated, as indicated by reference 545. If the ticket data is not associated with an existing ticket record, then the process 540 determines if the ticket is flagged for cancellation, as indicated by decision step 546. If yes, then the corresponding ticket data or record is deleted from the ticket table 300, as indicated by reference 547. The ticket table 300 is considered to be updated, i.e. “in sync” with the ticketing system 120, and the process for extracting ticket information 540 terminates or ends, as indicated by reference 548.

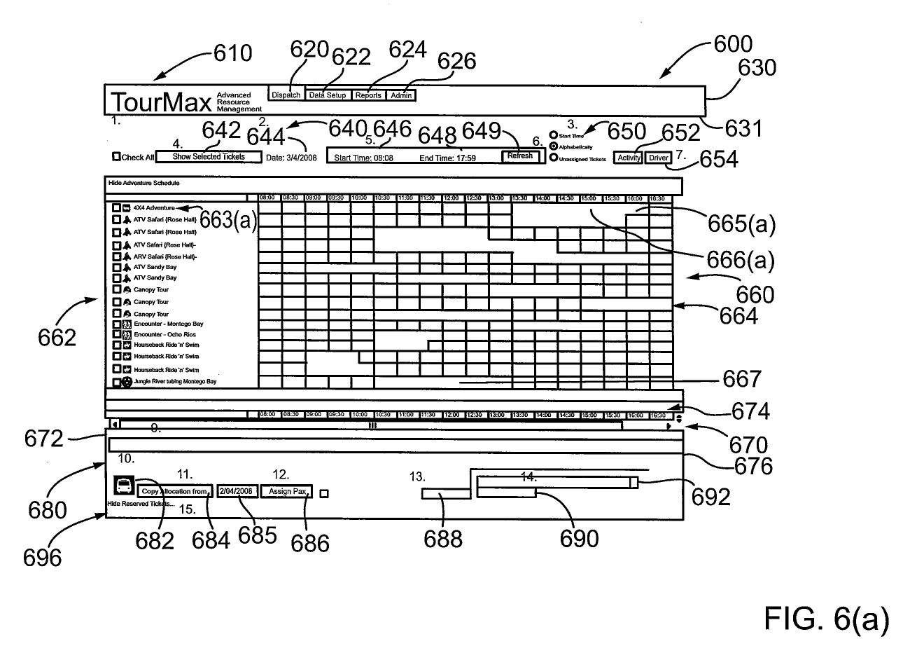

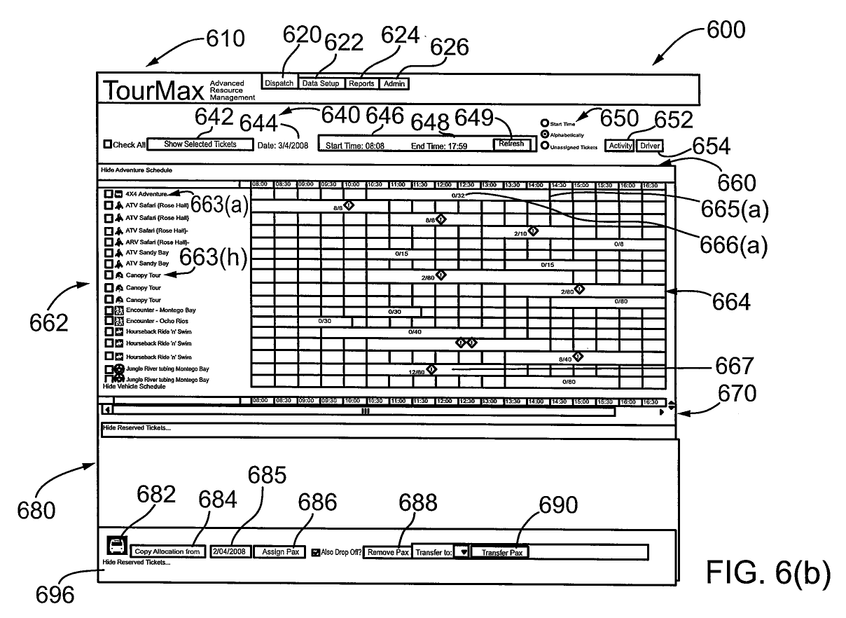

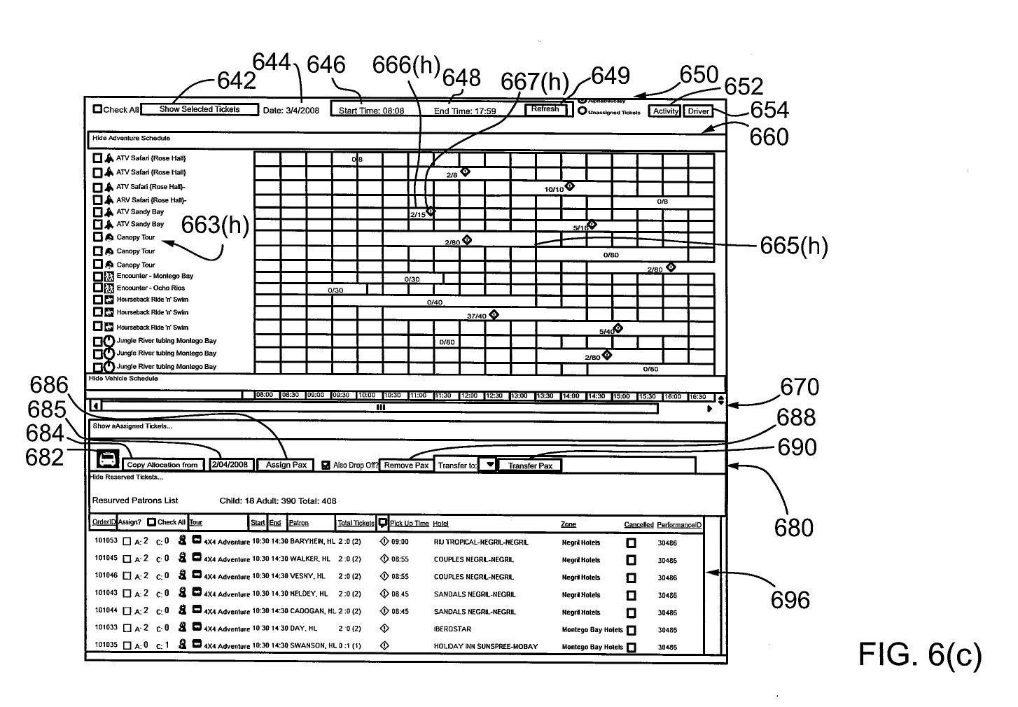

Reference is next made to FIGS. 6(a) to 6(c), which show screen shots of a dispatch screen according to an embodiment of the invention. The Dispatch screen is indicated generally by reference 600 and is configured to provide a number of functions and operations associated with the system 100.

According to an embodiment, the dispatch screen 600 includes a logo field indicated generally by reference 610. The logo field 610 provides the system 100 with a branding capability. According to one aspect, the logo field 610 may be customized by providing a left, centre and right image and referring to these in the CSS Style Sheet. According to an embodiment, the logo field 610 is configured by a developer, or other skilled technician, with access to the source code.

As shown in FIG. 6, the dispatch screen 600 is configured with four tabs: a “Dispatch” tab 620, a “Data Setup” tab 622, a “Reports” tab 624 and an “Administration” tab 626. The operation of the tabs is described in further detail below. The dispatch screen 600 includes a logged in user(s) bar indicated by reference 630. The logged in user(s) bar 630 is configured to provide information about the user(s) logged into the system 100 and the territory in which they have been set up in. According to an embodiment, the territory designation comprises a user rights category which restricts user from dispatching resources outside of their own physical location or ‘ternitory’. The logged in users bar 630 includes a logout button 631. The logout button 631 is configured to close the window, i.e. the dispatch screen 600. According to an embodiment, the logout button 631 is configured as a security feature and closing the dispatch screen 600 causes the session to be lost. Closing the dispatch screen 600 also serves to prevent unauthorized access from that machine.

As shown, the dispatch screen 600 includes a date filter options control or panel, indicated generally by reference 640, an Event, e.g. “Adventure Schedule”, screen or window 660, a “Vehicle Schedule” screen 670, an “Assigned Tickets” screen 680, and a “Reserved Patrons List” screen 696.

The Vehicle screen 670 is configured to display resources, in this case vehicles, that have been allocated or assigned to one or more of the events listed in the event schedule screen 660. According to an embodiment, the vehicle(s) are represented by icon(s) which are displayed in the Vehicle screen 670 as indicated by reference 672. The Vehicle Schedule screen 660 includes a time bar 674 for each of the vehicles which shows the scheduled or allocated time(s), for example, in half hour increments, for the vehicle. The time bar 674 may be displayed as a shaded or colored graphic element. According to another aspect, the time bar 674 includes an information field 676 which shows the capacity and load for the vehicle.

Referring again to FIG. 6, the Adventure (Event) Schedule screen 660 comprises the main portion of the dispatch screen 600 and is configured to present or display a list of events, i.e. the events booked through the reservation system 120 (FIG. 1), and scheduling information associated with the events. According to an embodiment, the Adventure Schedule screen 660 comprises a screen element 662 which lists the events (i.e. the events booked through the reservation system 120) and a screen element 664 which provides a scheduling information grid. According to an embodiment, each event comprises a row and the scheduling information comprises a plurality of columns and each of columns is based on a time increment, for example, 30 minute increments. As shown, a checkbox is provided for each of the listed events and checking any one or more of the checkboxes provides the capability to further manipulate the associated with the events. As shown in FIG. 6, shaded bars (for example, in the colour yellow) are displayed on the schedule grid 664 to indicate ticketing or reservations for the associated event. The shaded bars are indicated generally by reference 665 and the length of the bar 665 is based on the scheduled time or duration of the event. Within the bars additional information, such as, a ratio of the number of tickets sold to tickets available may be provided, as indicated by reference 666. According to another aspect, an indication in the form of an icon 667, for example, a yellow diamond explanation marker in HTML, may be provided to indicate that there are unassigned tickets. For example, the first event (indicated by reference 663(a)) in the event list 662 is a “Canopy Tour”. The Comedy Tour event 663(a) is scheduled between 13:30 and 16:00 hours as indicated by the shaded bar 665(a) and the ticket ratio is indicated by reference 666(a).

According to another aspect, the dispatch screen 600 is configured to display the bars 665 in different colors. One or more of the bars 665 are displayed in yellow to indicate event(s) (e.g. “adventures”) that include non-dispatched tickets. One or more of the bars 665 are displayed in green to indicate event(s) (e.g. “adventures”) that are overfilled. One or more of the bars 665 are displayed in green to indicate event(s) (e.g. “adventures”) that have cancelled tickets. One or more of the bars 665 are displayed in red to indicate event(s) (e.g. “adventures”) that have printed tickets.

According to another aspect, the bars 665 are configured to be responsive to a user input, for example, a mouse click. In response to being “clicked”, the application 148 runs or executes a process (e.g. a function) that highlights the bar 665, for example, displays a dark colored border around the bar 665. The application 148 is also configured to execute a process or function that highlights all of the resources, e.g. vehicles in the Vehicle screen 680, which have been assigned to the event. According to another aspect, the application 148 is configured to execute a process or function that responds to the vehicle icon being clicked and highlights the events associated with that vehicle.

The Assigned Tickets screen 680 is configured to display or show the event tickets that have been allocated or assigned to a resource, which in this case is a vehicle. As shown in FIG. 6 and according to an embodiment, the Assigned Tickets screen 680 comprises a “New Vehicle Allocation” button 682, a “Copy Allocation” button 684, an “Assign PAX” button 686, a “Remove PAX” button 688, and a “Transfer PAX” button 690. In the context of the present description, PAX refers to “patrons”. The “New Vehicle Allocation” button 682 is configured to be responsive to user action, e.g. a mouse click, and displays all the tickets assigned to a vehicle, for example, using a grid representation. The vehicle is selected using the Vehicle screen 670 described above.

The Copy Allocation button 684 is configured to allow a user, e.g. a dispatcher, to copy allocations made for a resource, e.g. a vehicle, on a previous date to the date specified in a date field indicated by reference 685 in FIG. 6. The Copy Allocation button 684 and associated process in the application 148 provide a template function that allows a dispatcher to use the vehicles from a previous standard date or from any date which contains a layout similar to that which is desired. Once the template has been copied to the new date, the dispatcher is free to customize the allocation, for example, by changing vehicles, drivers, start and end times, overriding the vehicle capacity and/or the start and/or end locations.

The Assign PAX button 686 is configured and implemented as a process in the application 148 to assign selected passengers to a resource, i.e. a vehicle. According to an embodiment, the passengers are selected by entering a check mark into the order row which is unassigned. A portion of the entire party may be selected by entering the number of Adults (A) and Children (C) which are desired to be transferred to the bus. Individual tickets are not identified, but each person in the party (order) is indistinguishable from others, unless a comment has been manually entered in the reservation system. For example, any patrons from a ship may go on any bus to which that order has been assigned up until the capacity allowed for that order has been reached. i.e. it is not necessary for certain people to go on certain vehicles.

The Remove PAX button 688 is configured and implemented as a process in the application 148 to provide the functionality to remove patron(s) (PAX) from the selected vehicle. According to a further aspect, a checkbox prompt 689 is provided to also remove the patron from an associated drop-off leg.

The Transfer PAX button 690 is configured and implemented as a process in the application 148 to provide the functionality to transfer patron(s) (PAX) to another leg or segment of a tour or event which occurs in the future. According to an embodiment, a patron, i.e. a passenger, is assigned to the legs of interest in a time sequential order, and the patron can be transferred to any future leg on that day. As shown, the Transfer PAX button 690 includes a drop-down list box 692 which lists the legs. To transfer patrons, the leg is selected from the list box 692 and the number of patrons to be transferred is selected, and then the Transfer PAX button 690 is clicked to transfer the selected patrons to another vehicle.

The Reserved Patrons List 696 shows all the patrons which have booked tickets. Once the patrons have been assigned to a vehicle, then they are no longer able to be moved from the reserved list, but must instead be moved from the vehicle itself.

Referring again to FIG. 6, the date filter options 640 comprise a “Show Selected Tickets” button 642, a “Date” field or box 644, a “Start Time” field 646, an “End Time” field 648, and a “Refresh” button 649. A “Check All” box 641 is also provided. The Start Time and End Time fields 646, 648 are provided to allow a dispatcher to display the portion of the day of interest. The day is set using the “Date” field 644. The “Check all” box 641 is configured to allow the dispatcher to select all tours or events for use, i.e. instead of to save checking each box manually. The “Show Selected Tickets” button 642 is configured to show all tickets for selected tours or events. The “Refresh” button 649 is used once the Date 644 and Time 646, 648 fields have been filled or populated.

As shown in FIG. 6, the dispatch screen 600 also includes a button panel 650 for providing further filter/display options for the Adventure Schedule screen 660. According to an embodiment, the button panel 650 includes a “Start Time” arrangement button, an “Alphabetically” arrangement button, and an “Unassigned Tickets” arrangement button. The Start Time arrangement button is configured to cause the tours or events to be arranged in the Adventure Schedule screen 660 by earliest to latest start times. The “Alphabetically” arrangement button is configured to arrange the events alphabetically in the Adventure screen 660. The “Unassigned tickets” arrangement button is configured to arrange the events in the Adventure Schedule screen 660 according to the number of tickets with unassigned resources.

As shown in FIG. 6, the dispatch screen 600 also includes an “Activity” button 652 and a “Driver” button 654. The Activity button 652 is configured to display an activity report, e.g. a daily activity report. The Driver button 654 is configured to display a driver report. According to another embodiment, this report may be transmitted to the driver over a wireless communication device, such as a BlackBerry device, or other PDA type device, capable of receiving information, allowing changes made to, or additional pickup of patrons (PAX) to be made during the driver's route.

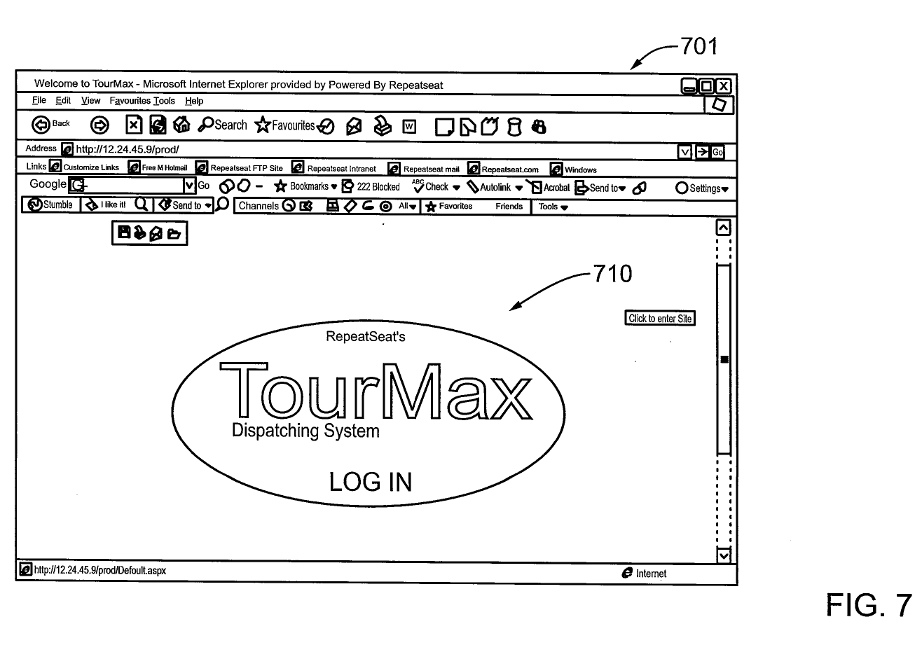

Reference is next made to FIGS. 7 to 15, which further illustrate operation of the system 100 (FIG. 1) and processes/logic configured in the application 148 (FIG. 1) according to an embodiment by way of an exemplary event comprising a ticket reservation or booking.

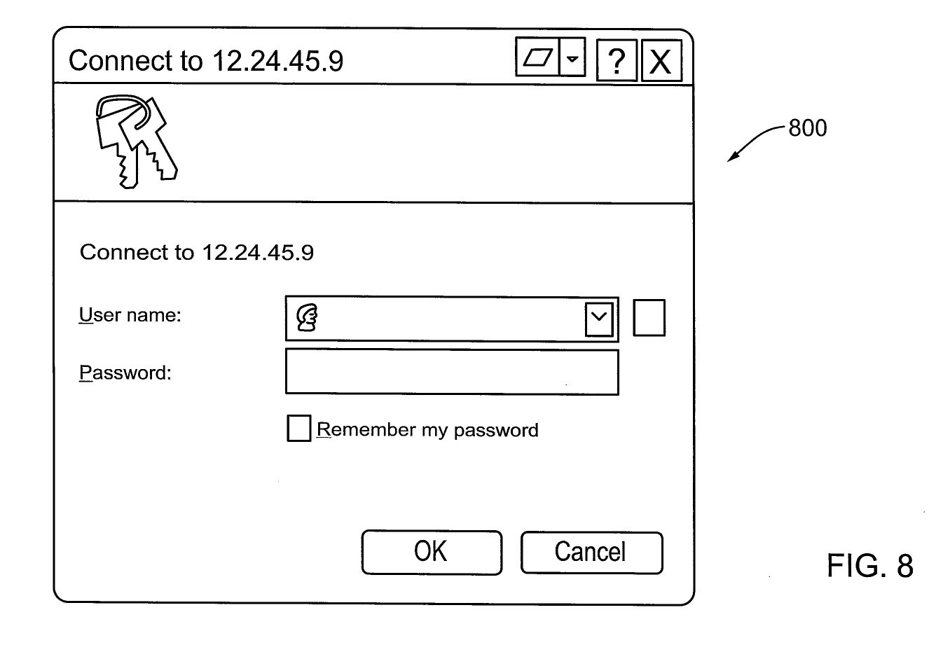

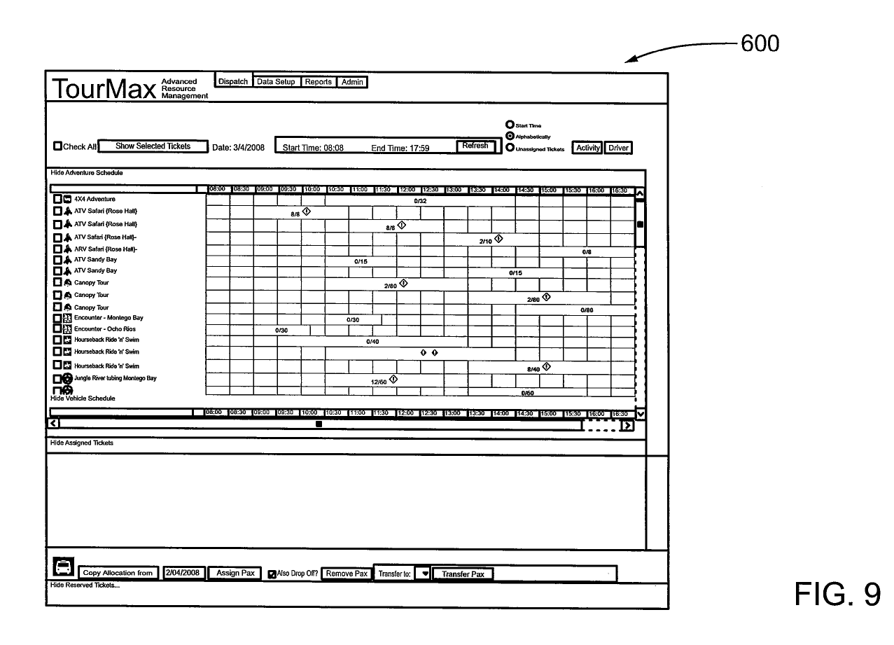

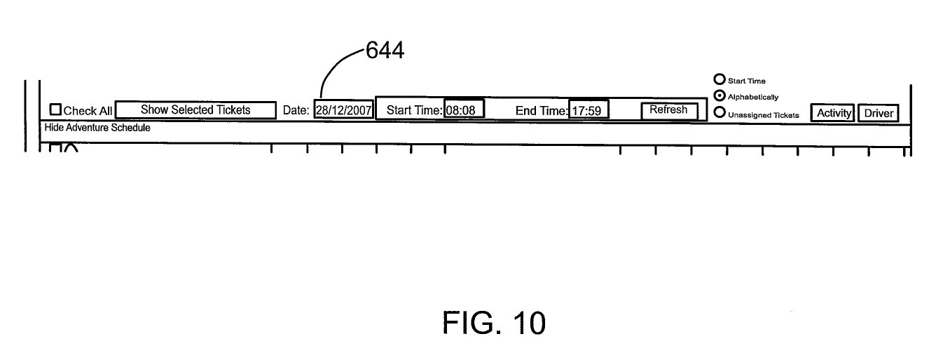

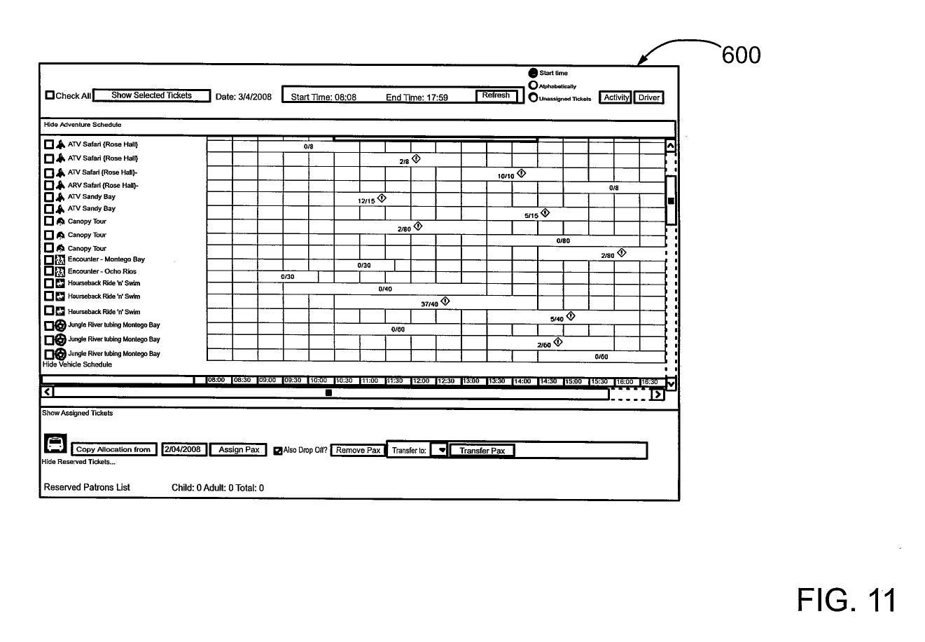

In a server/client configuration, a user opens an Internet browser program 701, such as Microsoft Internet Explorer, and enters a URL to access a web page 710 having a form for example as shown in FIG. 7. The user is then presented with a Login screen 800 as shown in FIG. 8. In response to the user providing the proper credentials, i.e. user name and password, the user is logged in and the application 148 is configured to display the Dispatch screen as shown in FIG. 9. The Dispatch screen is the same as the dispatch screen 600 described above with reference to FIG. 6. According to an embodiment, the dispatch screen 600 displays the information to the current (i.e. “today's”) date. If the user wishes to display data for another date, then the user enters the date of interest in the Date field 644 as illustrated in FIG. 10.

Reference is made to FIG. 11, which illustrates a resource allocation where a vehicle is made available in a time slot for transporting patrons (PAX) from their hotel to a tour launch site and then back to their hotel after the tour. According an embodiment, a time slot is configured and a resource (e.g. a vehicle) is made available before the resources are assigned to an event, e.g. a tour, in order to allow patrons or PAX from an order to be moved into the allocation.

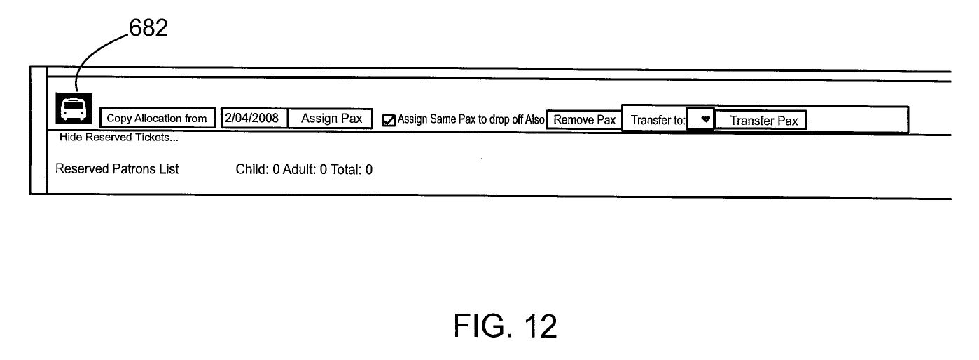

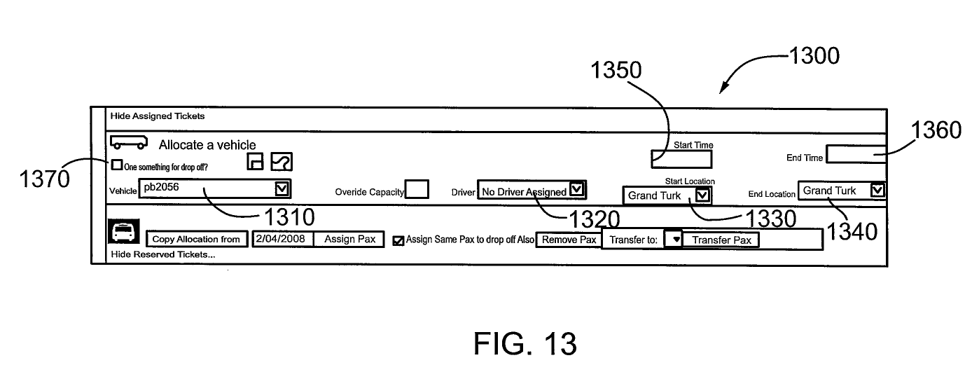

Reference is next made to FIG. 12, which shows the process for creating an allocation. As illustrated in FIG. 12, a user clicks on the Vehicle icon 682 to invoke or display a New Allocation screen or panel having a form as shown in FIG. 13 and indicated by reference 1300. As shown, the New Allocation screen 1300 comprises a Vehicle drop-down menu 1310, a Driver drop-down menu 1320, a Start Location drop-down menu 1330, an End Location drop-down menu 1340, a Start Time field 1350 and an End Time field 1360. The New Allocation screen 1300 also includes a check box 1370 for designating the pick up vehicle the same as the drop off vehicle. In operation, the user selects a pre-defined vehicle from the Vehicle drop-down menu 1310, and then assigns a driver to the vehicle using the Driver drop-down menu 1320. The user then selects a start location from the Start Location drop-down menu 1330 and an end location from the End Location drop-down menu 1340. The user also defines a start time and an end time for the vehicle (i.e. resource) allocation using the Start Time 1350 and End Time 1360 fields. The user selects the check box 1370 to mirror this allocation for a drop off, i.e. the allocation for the drop off leg will utilize the same driver, vehicle and time slot. The allocation is completed by clicking a Save button.

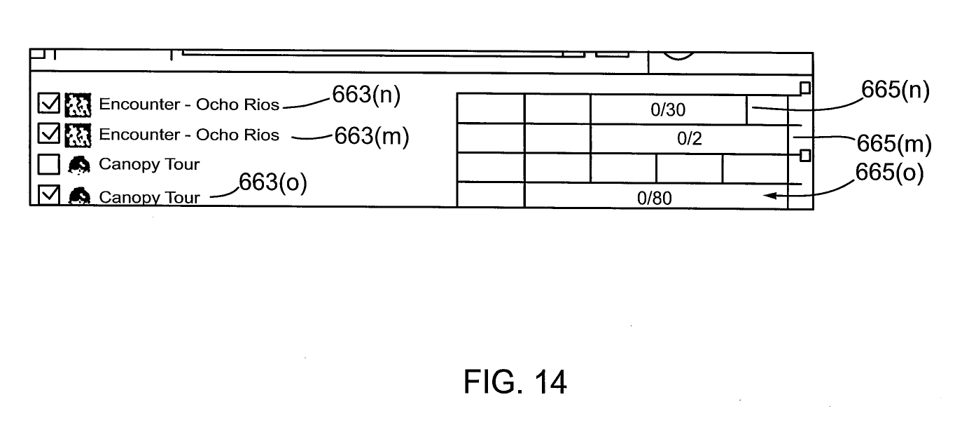

Reference is next made to FIG. 14, which shows a partial screen shot of the Event (i.e. “Adventure”) Schedule screen 660. As illustrated according to this example, the user selects the events or tours for resource management/allocation by checking a check box associated with each of the events 663. In alternative, the Event screen 660 is configured to be responsive to the user clicking the shaded bar 665 associated with the selected event 663. As described above, the bar 665 indicates the time slot(s) in which the event exists. According to an embodiment, if the user selects an event which has no tickets sales in it nothing will happen; however if there is ticket sales data for that event the information will populate in a field directly below the Adventure Schedule screen 660.

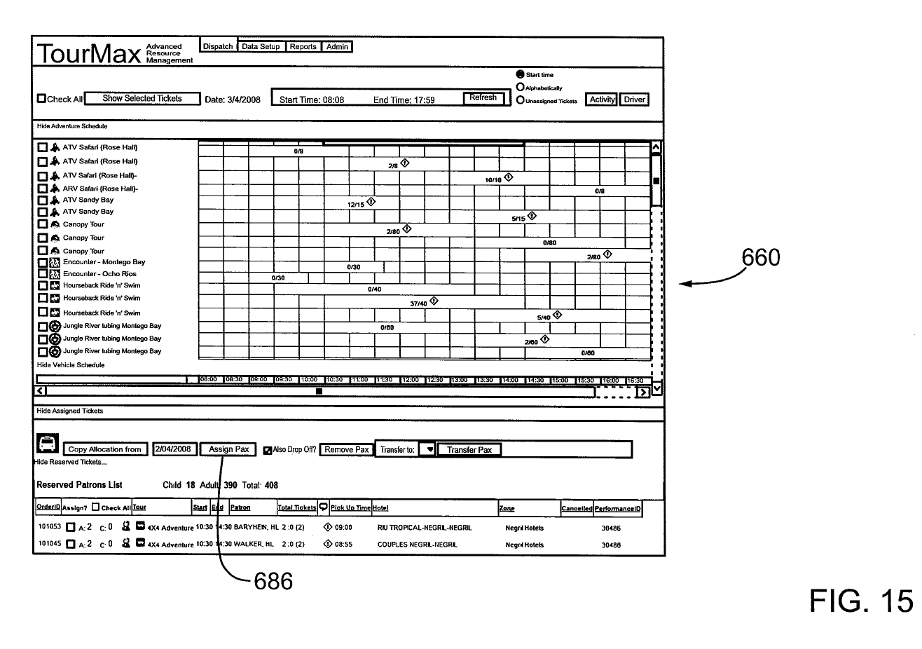

Reference is next made to FIG. 15, and in particular the Reserved Patron List screen in the dispatch screen 600. The user clicks the Assign PAX button 686 to add the unassigned patron(s) (or tickets) to the resource allocation and complete the assignment or allocation. These steps are repeated to complete the other resource assignments for the day. In addition, the user can print a driver pick-up report which lists the patrons for the tour and the pick-up report is distributed to the vehicle (i.e. bus) drivers.

The steps performed by a user in the operation of the system 140 according to an embodiment may be summarized as follows:

log in

enter search criteria for events (tours)

click “refresh”

select event(s) with unassigned patrons (PAX) or sales in them

click “show selected tickets” to view all tickets and their details.

select a resource allocation to assign the patrons (PAX)

select the PAX within the selected events

click assign patrons (PAX)

(optional) print driver pick up report

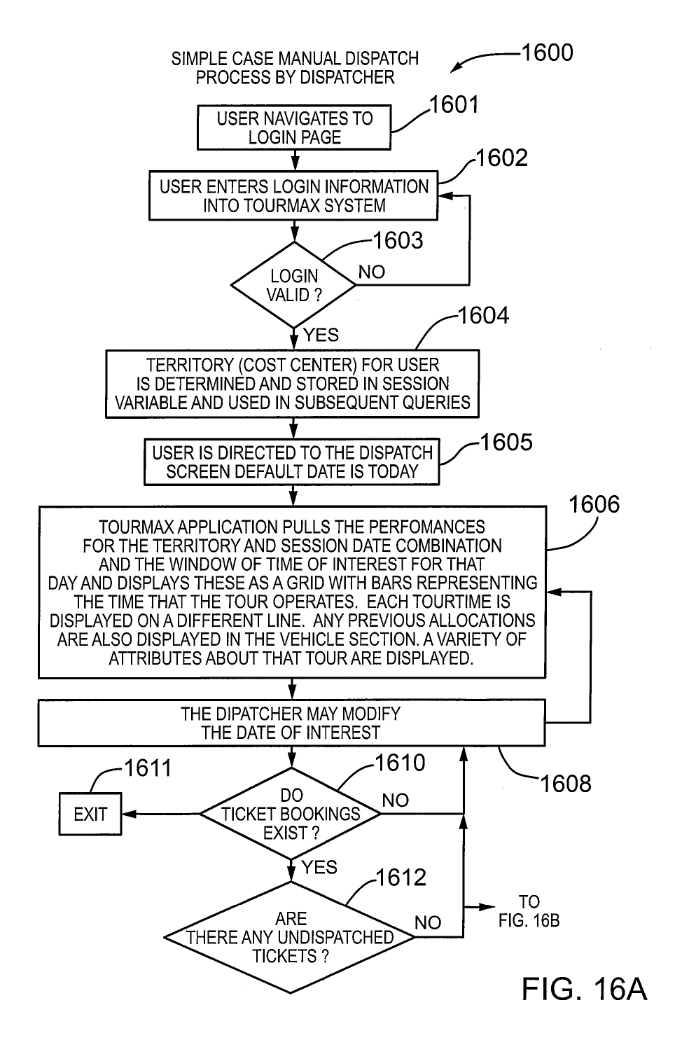

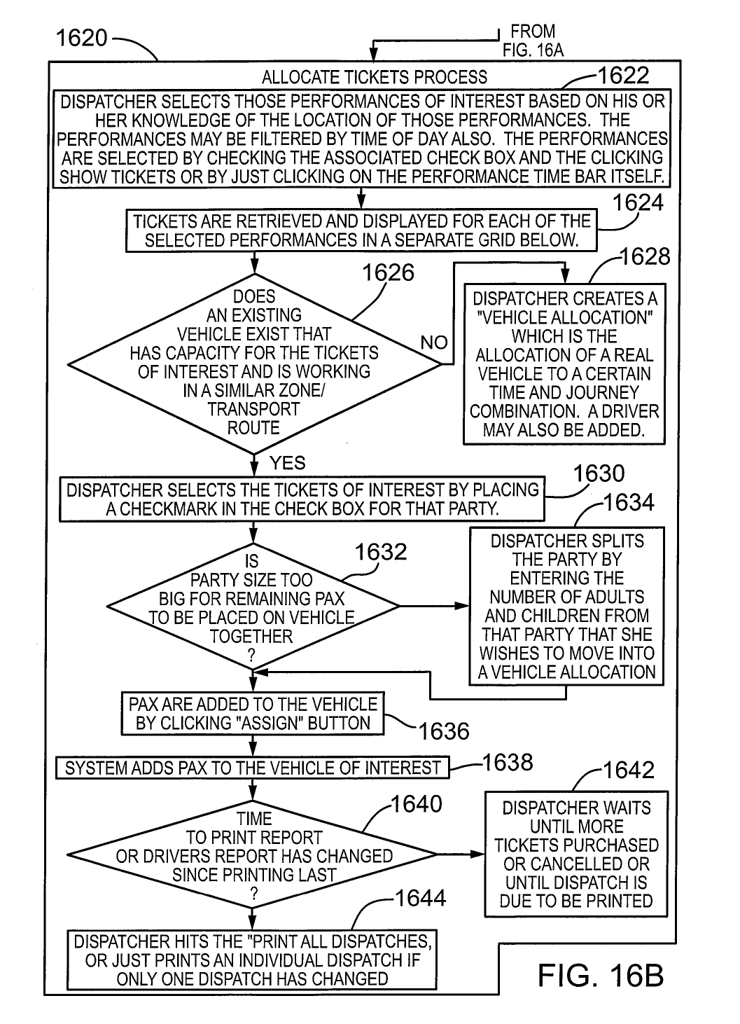

Reference is next made to FIG. 16, which shows in flowchart form a dispatch process according to an embodiment and indicated generally by reference 1600. As described above, once an order is successfully processed in the reservation or ticketing system 120 (FIG. 1), the ticket or reservation information is copied or transferred to the event resource allocation and management system 140 (FIG. 1). The first step indicated by reference 1601 comprises a user navigating to the login page (FIG. 8) and entering their credentials, i.e. username and password, in step 1602. If the login is valid (step 1603), a territory for the user is determined and stored for session as indicated by step 1604. The user is directed to a dispatch home screen and the home screen is defaulted to today's date as indicated by step 1605. The application 148 is configured to retrieve and display the results (data) for the territory and session date combination along with the date/time search criteria, as indicated by step 1606. As indicated by step 1608, the user may modify search criteria, such as the date of interest. Next in step 1610, the existence of reservations or bookings within the search parameters is confirmed. If no bookings exist, then the process 1600 terminates (step 1611) or the user changes the search criteria in step 1610. Next, the existence of un-dispatched reservations or bookings within the search parameters is confirmed in step 1612. The process 1600 then proceeds to an allocate ticket process indicated generally by reference 1620.

As shown in FIG. 16, the ticket allocation process 1620 begins with a user selecting events within the allowable parameters of the preset system settings in order to view the associated tickets, as indicated by step 1622. The tickets are retrieved and displayed for each separate performance or event in the Event Schedule screen 660 (FIG. 6), as indicated in step 1624. Next a determination is made whether the existing resource allocation fits within the parameters of the resource assignment needs, as indicated in step 1626. If the existing allocations are not suitable, then the user creates new allocation, as indicated in step 1628. Otherwise, the user selects tickets of interest for placement within allocation, as indicated in step 1630. Next a determination is made if the allocation size is suitable for number of tickets or patrons (PAX) that need to be assigned to the resource, as indicated in step 1632. If the allocation size is not suitable, then the user moves other tickets or PAX to another allocation, as indicated in step 1634. Otherwise, the patrons (PAX) or tickets are assigned to the resource (e.g. vehicle), as indicated in steps 1636 and 1638. Next, the user is given the option of printing one or more reports as indicated in steps 1640 and 1642. The user finalizes the dispatch session by printing required reports resulting from current session, and/or previous sessions, as indicated in step 1644.

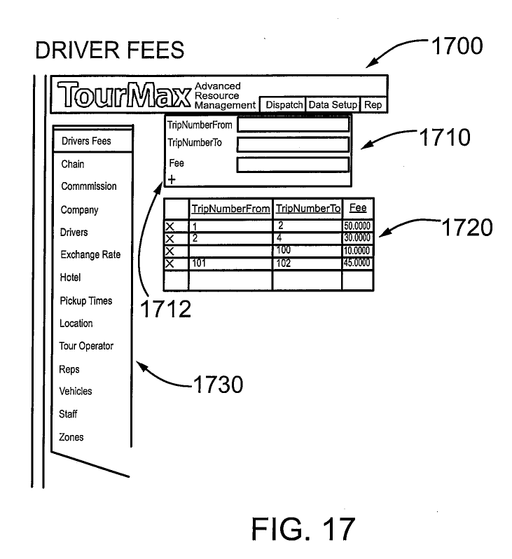

Reference is next made to FIGS. 17 to 27, which show screen shots of exemplary screens configured for capturing, viewing, updating and/or deleting data from the event resource allocation and management system 140 (FIG. 1). Each of the screens comprises a substantially common layout or structure as illustrated in FIG. 17.

FIG. 17 shows a screen shot of a Driver Fees screen 1700 which is configured for an administrator to set up the fees that are paid to an internal driver for the trips he makes each day. This information in combination with the dispatch information is used to generate reports that show how much a driver should be paid for the period of time selected in the report. According to an embodiment, this information can also be transmitted to the tour company's accounting and/or payroll systems. As depicted in the Driver Fees screen 1700, the screens include a detail form 1710 which provides for the entry of information in order to create the desired entity. The screen includes a “plus” (+) button 1712 which is configured to execute or submit the information to the web server 142 (FIG. 1) for processing. According to an embodiment, the detail form 1710 is implemented with AJAX technology to enhance the user's visual experience and performance of the execution action. The screen may also include a Grid 1720. According to an embodiment, the Grid 1720 is configured to display up to 100 rows. The rows may be configured to be editable, for example, the screen is placed in an edit mode when the user presses an edit button. In edit mode, the user may be presented with additional controls such as text boxes, dropdowns or calendars which can be used to modify the information about that entity. A cancel or a save button terminates the edit mode or saves the information and returns the user to the grid view, and the user is redirected to the regular display view. As shown, the Driver Fees screen 1700 also includes a screen list 1730. The screen list 1730 is common to the screens and is configured (e.g. as HTML links) to allow a user (i.e. administrator) to move between the various screens.

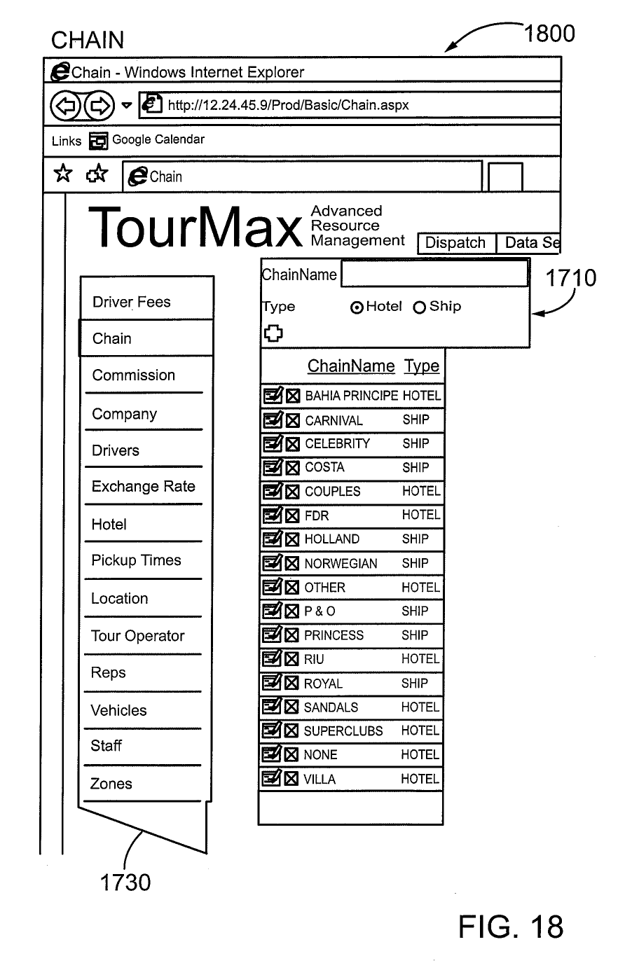

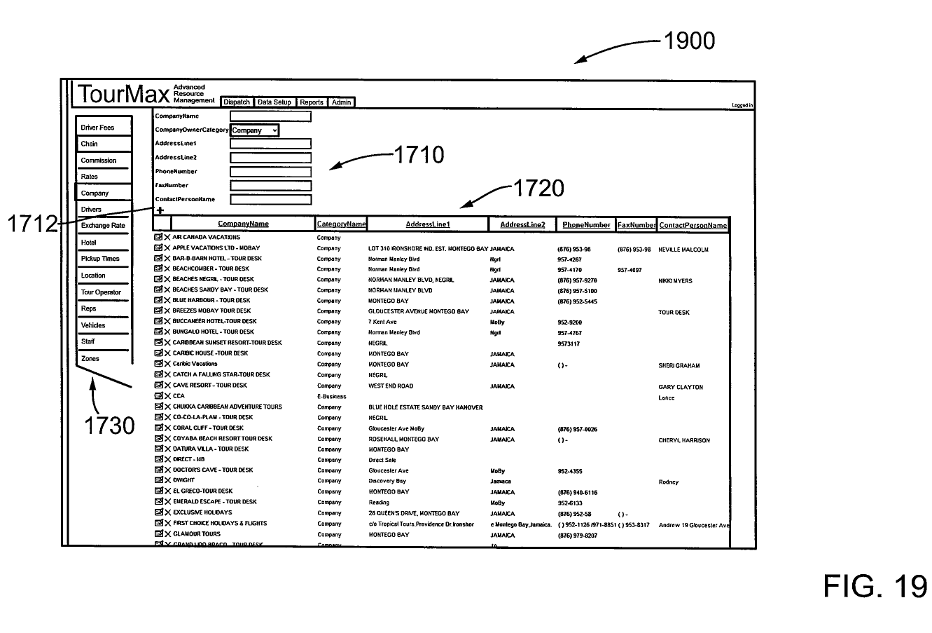

Reference is made to FIG. 18, which shows a Chain screen 1800. According to an embodiment, the Chain screen 1800 is configured to provide management information about the performance of hotels in supplying passengers to the business.

According to an aspect of the system, each Tour Operator falls into a commission category, and the system is configured to allow a user to create different percentage commissions and assign one of these categories to a tour operator. The percent commission for that tour operator is used to create a report and invoices which are sent to the tour operator (usually a hotel). According to an embodiment, this information can be transmitted to the tour company's accounting and/or payroll systems.

Reference is next made to FIG. 19, which shows a Company screen 1900 according to an embodiment. The Company screen 1900 is configured to allow a user to create, update and delete data associated with a “company”. In the context of the present description, a company comprises an organization that interacts with the system, such as contract driver companies, tour operators, agents, or the tour operator itself. Some of this information is used on reports.

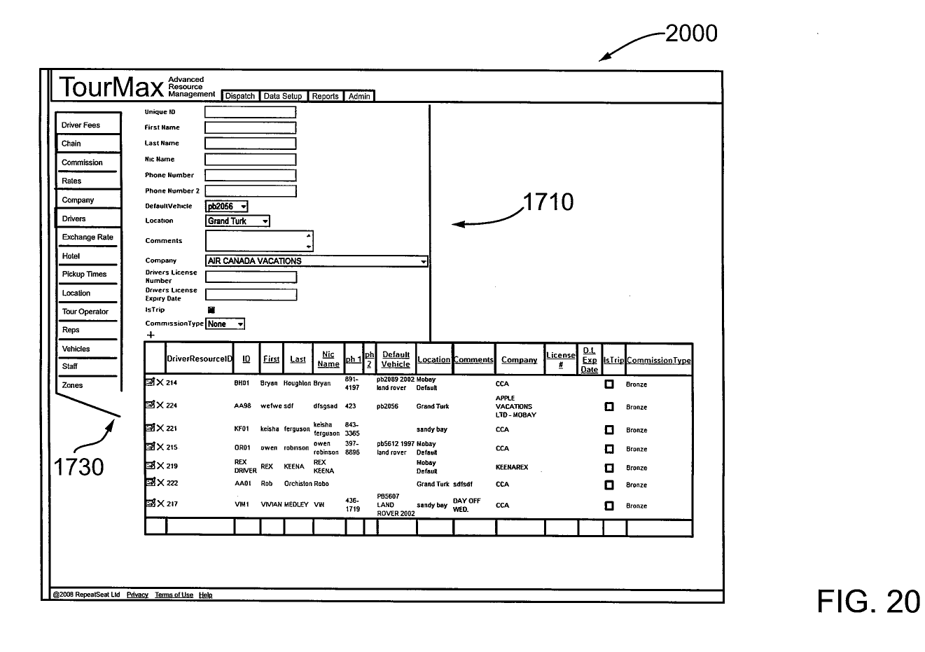

Reference is next made to FIG. 20, which shows a Drivers screen 2000 according to an embodiment. The Drivers screen 2000 is configured for the management of driver information. According to an embodiment, each driver has a default vehicle which is the vehicle that the driver normally drives. Each vehicle can only have one default driver. This information is used for the dispatch process and the creation of reports on dispatching.

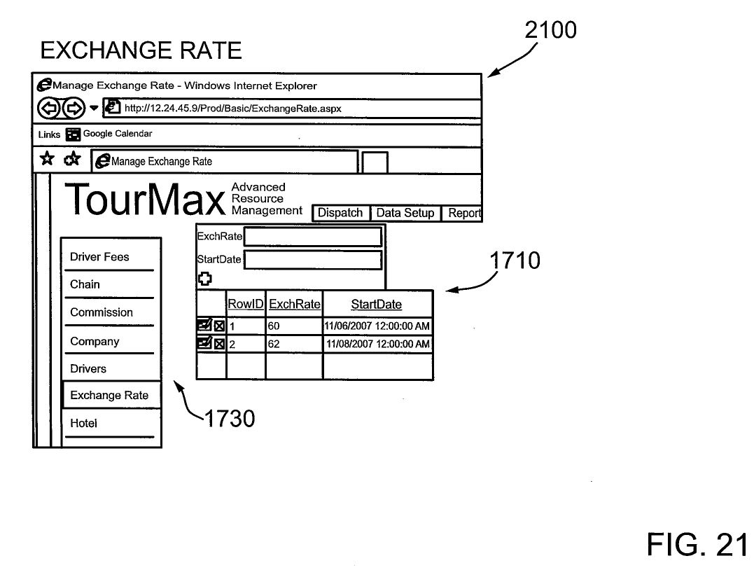

Reference is next made to FIG. 21, which shows an Exchange Rate screen 2100 according to an embodiment. The Exchange Rate screen 2100 is configured to set the exchange rate for past and future periods. Reports based on exchange rate look up the appropriate exchange rate for that period.

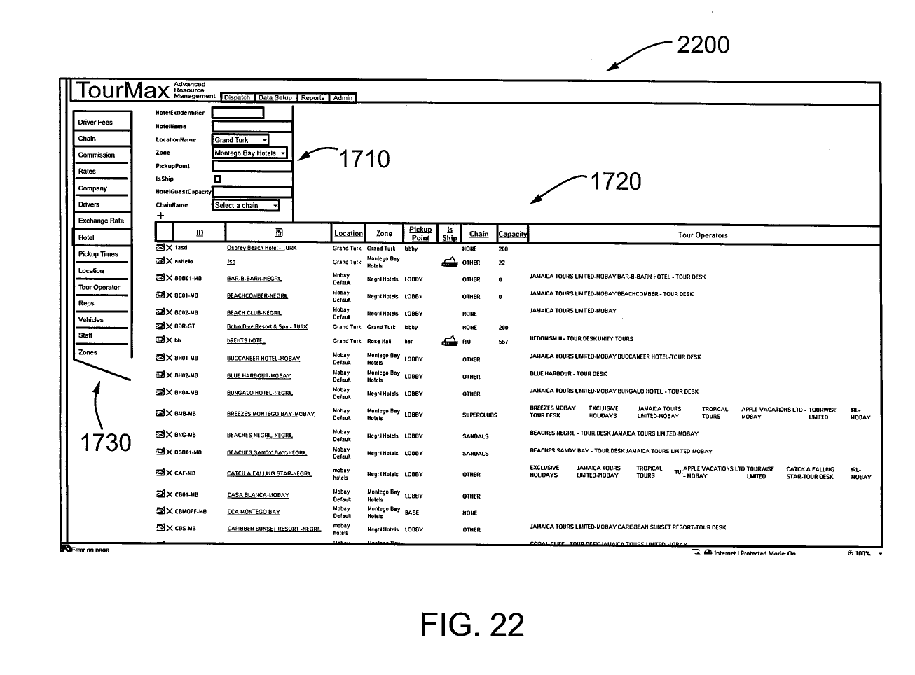

Reference is next made to FIG. 22, which shows a Hotel screen 2200 according to an embodiment. The Hotel screen 2200 is configured to manage hotel data. According to an embodiment, the Hotel screen 2200 is configured to treat ships as a special type of hotel, which is created for each instance in which they are in port. Each hotel may have from none to a multiple number of tour operators working from the hotel.

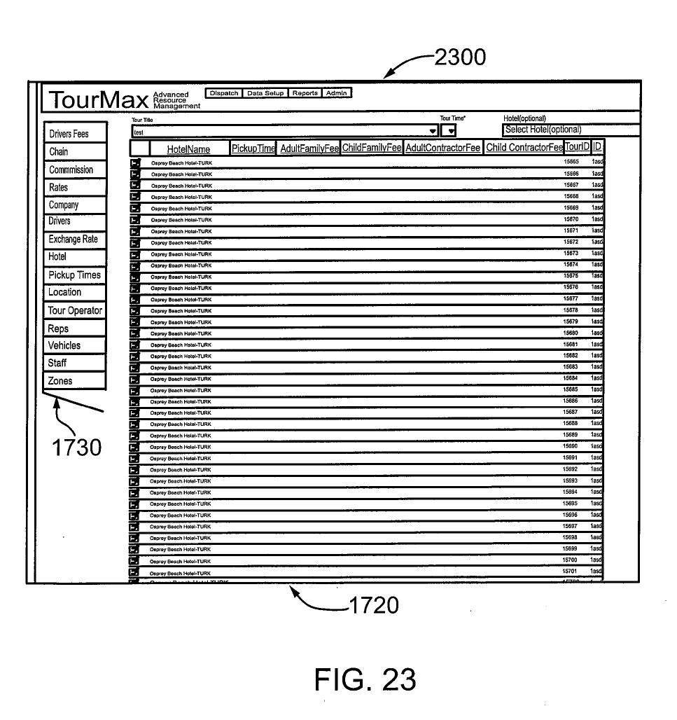

Reference is next made to FIG. 23, which shows a Pickup Times screen 2300 according to an embodiment. The Pickup Times screen 2300 is configured with a “Pickup Time” column 2300 and the pickup times are entered in the row associated with the various events. As shown, the Pickup Times screen 2300 also includes an Adult Fees column 2320a and a Child Fees column 2320b for entering respective fees associated with the event. The application 148 is configured (i.e. includes a process or function) to present or display data entered in the Pickup Times screen 230 in the dispatch screen 600 (FIG. 6) and the dispatch pickup report.

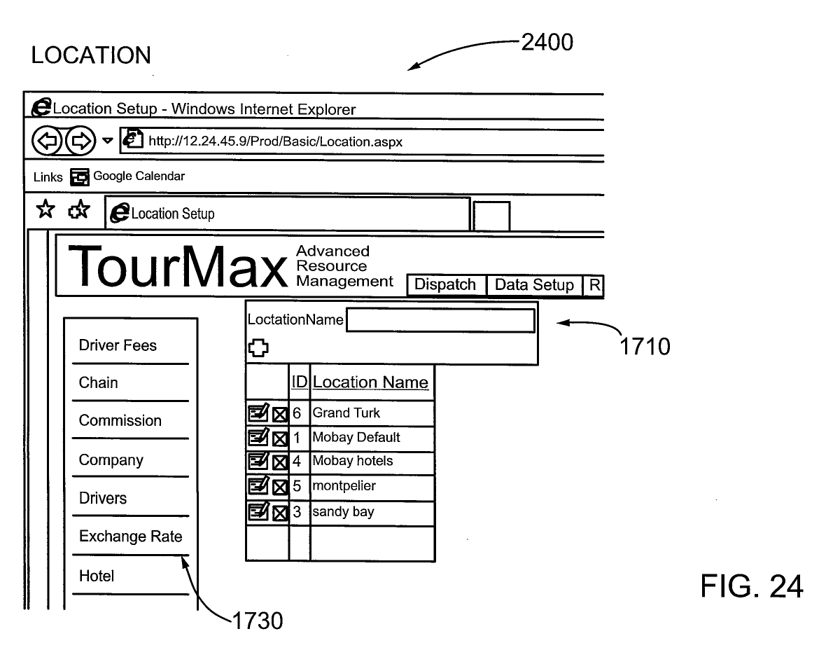

Reference is next made to FIG. 24, which shows a Location screen 2400 according to an embodiment. The Location screen 2400 is configured to enter location information associated with an event. In the context of a tour or excursions, locations comprise places, such as, the location where a tour occurs or any place that is a starting or stopping point or pickup or drop off location. Groups of hotels or single hotels may belong to a single geographic location in the system.

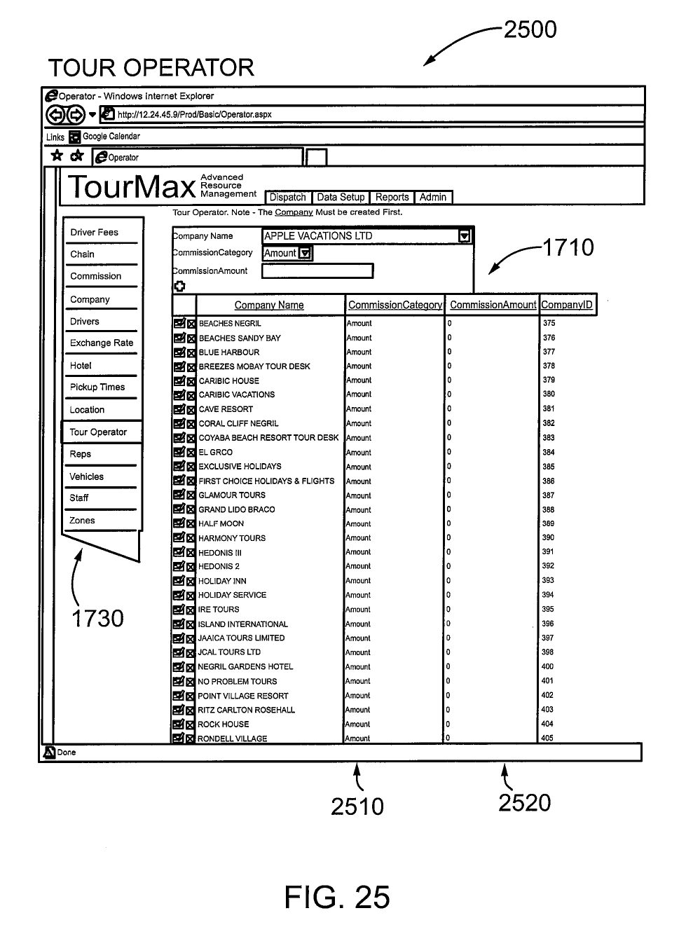

Reference is next made to FIG. 25, which shows a Tour Operator screen 2500 according to an embodiment. According to an embodiment, tour operators comprise specialist types of companies that sell tours, often from hotels. The tour operators may resell other companies tours and will typically receive a commission based on the volume of sales and their commission percentage rating. The Tour Operator screen 2500 is configured for the entry of tour operator information and comprises a “Commission Company” column 2510 and a “Commission Amount” column 2520. The Tour Operator screen 2500 includes a detail form 1710 for data entry, as described above with reference to FIG. 17.

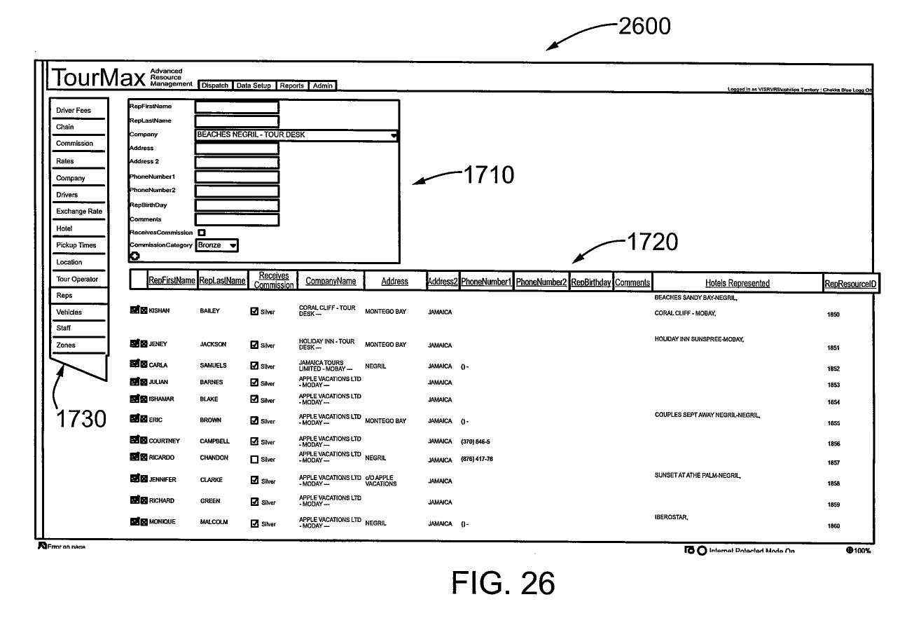

Reference is next made to FIG. 26, which shows a Reps screen 2600 according to an embodiment. In the context of the present description, “Reps” are individuals that work for the tour operators. Typically, the Reps receive a commission for their sales efforts. The Reps screen 2600 is configured for the entry of information associated with the reps and includes a detail form 1710 for data entry.

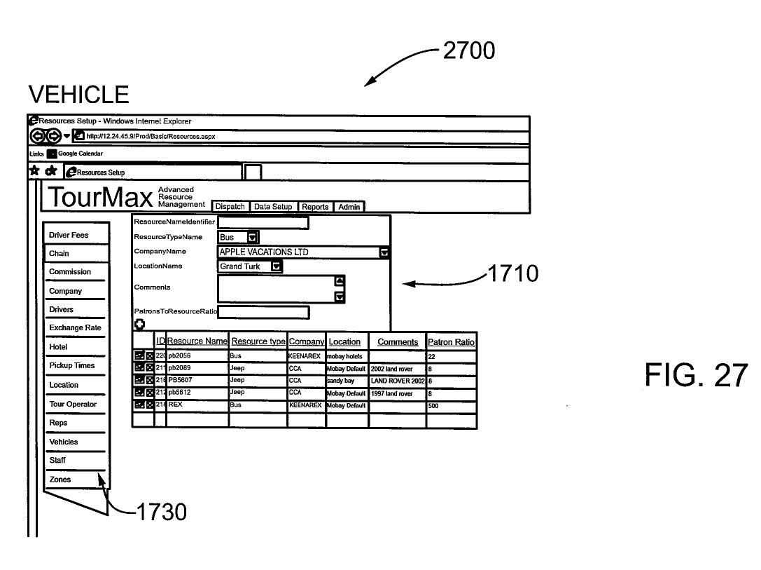

Reference is next made to FIG. 27, which shows a Vehicle screen 2700 according to an embodiment. The Vehicle screen 2700 is configured to capture information about vehicles (i.e. resources) and create corresponding dispatch(es). According to an embodiment, each vehicle has, or is assigned, a capacity and is of a configurable type (bus, jeep etc). According to a further aspect, each vehicle belongs to one of the companies and there is an arrangement where the dispatcher can dispatch vehicles of the company. The Vehicle screen 2700 includes a detail form 1710 which is configured with data input fields for “Vehicle Type”, “Vehicle Company” and “Vehicle Location”.

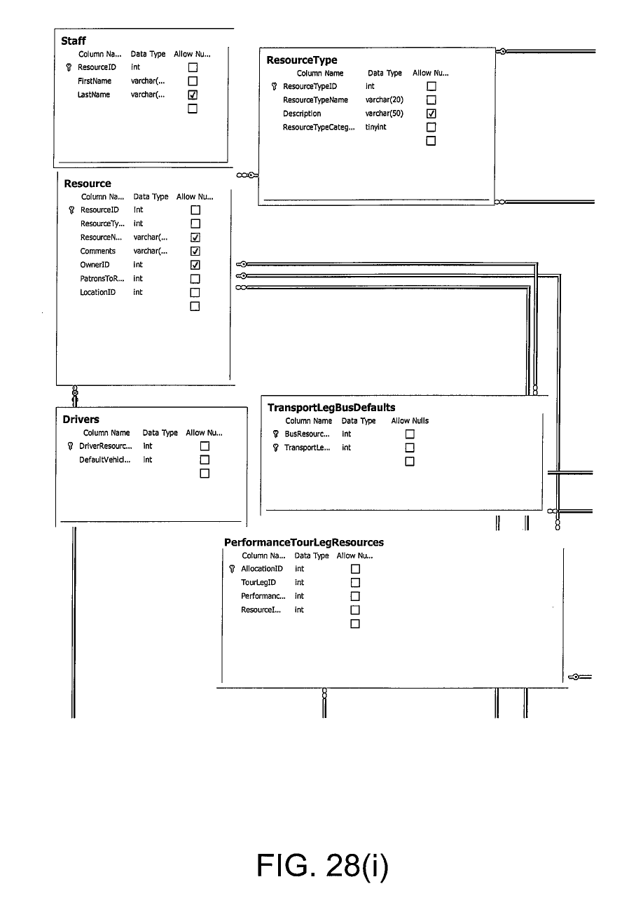

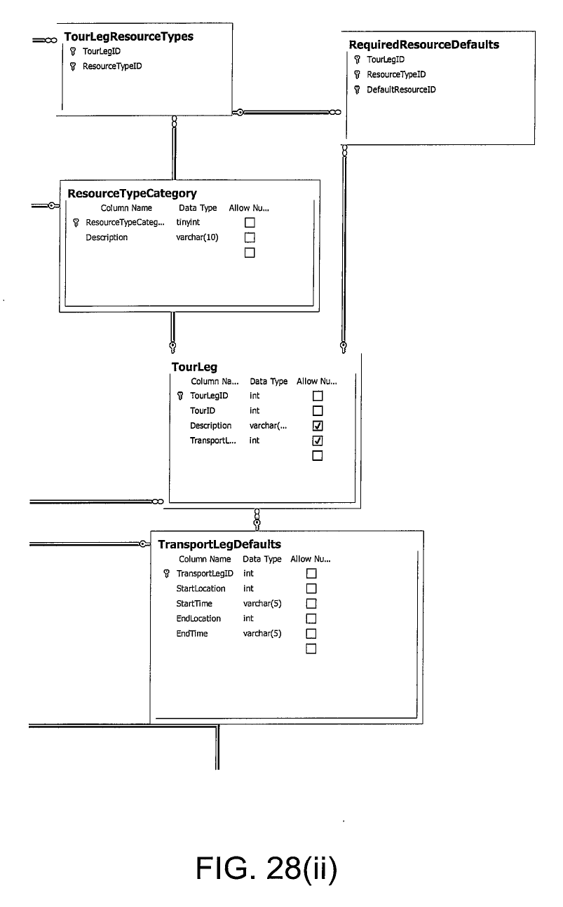

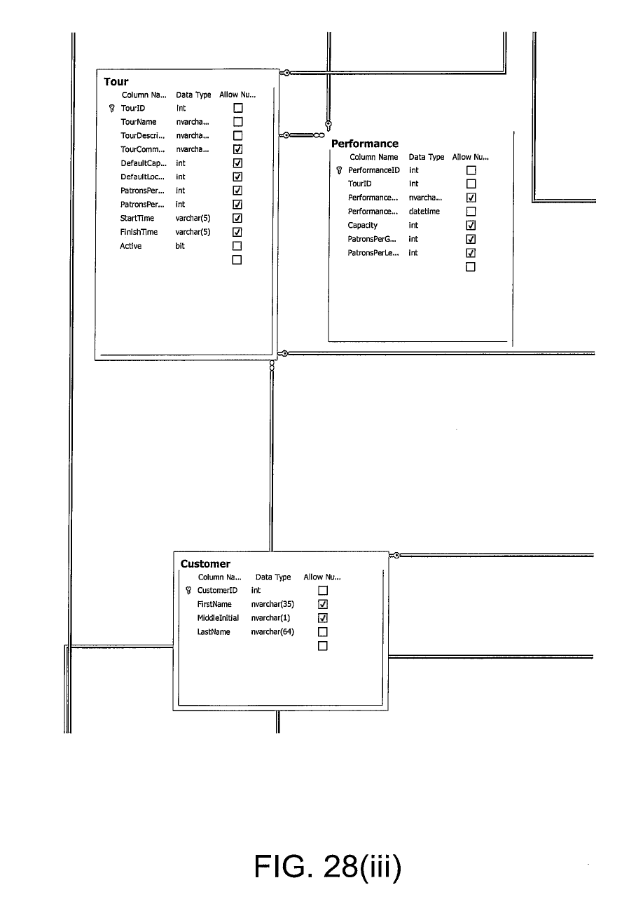

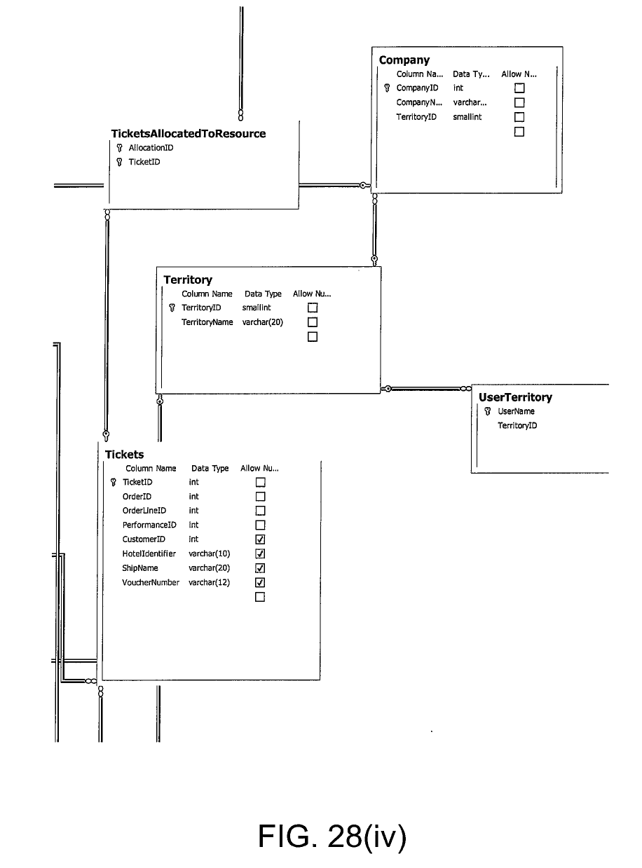

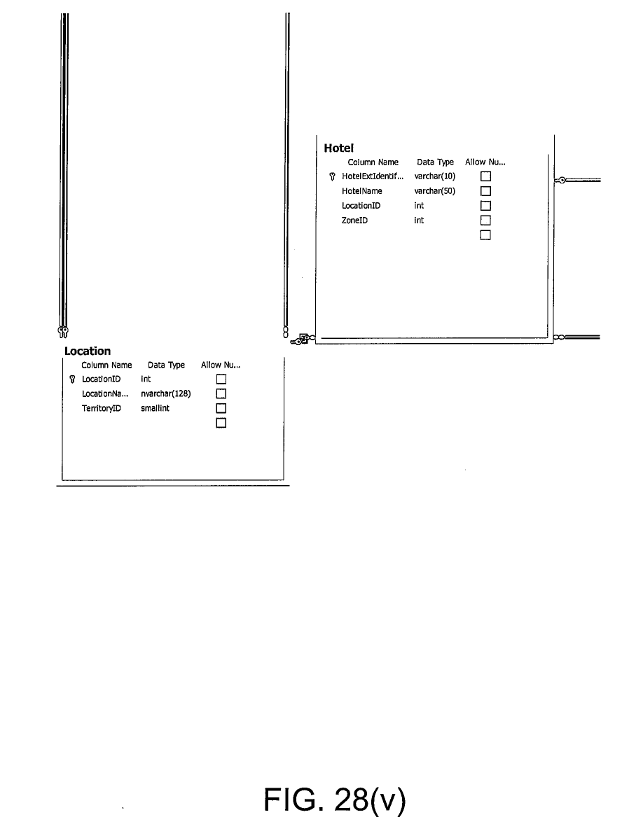

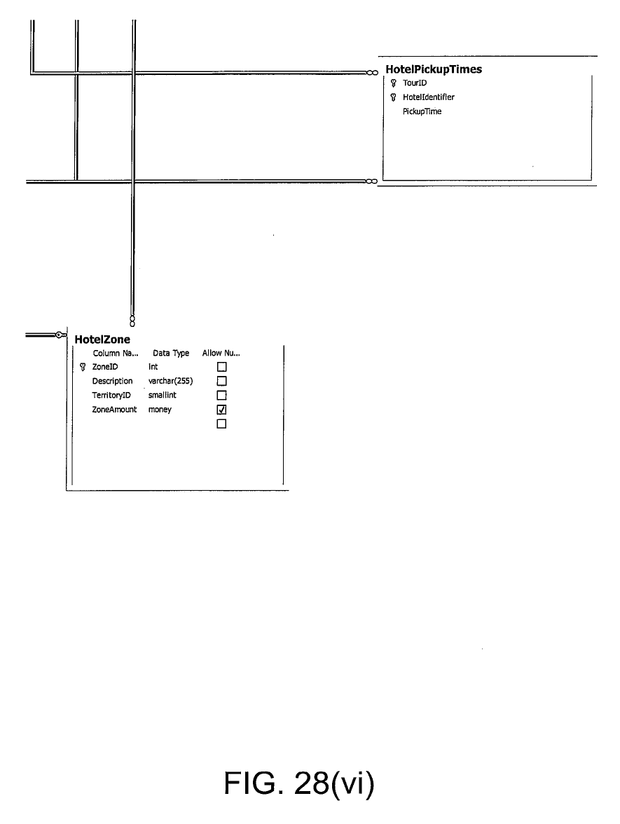

Reference is next made to FIG. 28(i) to (vi), which shows a database structure or schema according to an embodiment and indicated generally by reference 2800. The database schema 2800 is implemented or configured in the database server 144 (FIG. 1) and provides a structure for storing, accessing and/or manipulating data transferred from the reservation system 120 (FIG. 1) and/or data entered via the user interface screens for the application 148 (FIG. 1) as described above.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A system for allocating one or more resources to an event, said system comprising:
an interface for transferring event data from a reservation system;
a data structure for storing said event data;
a data structure for storing data associated with the resources;
a processor configured to allocate said one or more resources to the event based on said event data and said resources data.

2. The system as claimed in claim 1, further comprising a user interface module comprising a screen configured for displaying the allocation of said one or more resources to the event.

3. The system as claimed in claim 2, wherein said screen includes one or more controls for modifying the allocation of said one or more resources to the event.

4. The system as claimed in claim 3, wherein the event comprises an excursion and said one or more resources comprise a vehicle for transporting a plurality of patrons on said excursion.

5. A computer-implemented method for allocating one or more resources to an event, said method comprising the steps of:
obtaining event data from a reservation system;
making available one or more resources for the event; and
allocating said one or more resources to the event based on criteria associated with the event or said one or more resources.

6. The method as claimed in claim 5, wherein the event comprises an excursion and said one or more resources comprise a vehicle for transporting a plurality of patrons on said excursion.

7. The method as claimed in claim 5, wherein the event comprises one of a tour, an excursion, a sporting event, a concert, a theatrical performance, and a theatre movie show.

8. The method as claimed in claim 7, wherein said event data comprises ticketing information for the event.

9. The method as claimed in claim 8, wherein said criteria includes one or more of duration of the event, number of patrons attending the event, distance to the event, and capacity of the resources available.

10. A system for allocating one or more resources to an event, said system comprising:
a data transfer interface configured for transferring event data from a reservation system;
a data structure configured for storing said event data;
a data structure configured for storing data associated with the resources; and
a user interface module, said user interface module comprising a screen configured to represent some of said event data and some of said resources data, and said screen being configured to be responsive to one or more user inputs for allocating said one or more resources to the event.

11. The system as claimed in claim 10, wherein said screen includes one or more controls for modifying the allocation of said one or more resources to the event.

12. The system as claimed in claim 10, wherein the event comprises an excursion and said one or more resources comprise a vehicle for transporting a plurality of patrons on said excursion.

13. The system as claimed in claim 11, wherein the event comprises one of a tour, an excursion, a sporting event, a concert, a theatrical performance, and a theatre movie show.

14. A computer program product for allocating one or more resources to an event, said computer program product comprising:
a storage medium configured to store computer readable instructions;
said computer readable instructions including instructions for,
obtaining event data from a reservation system;
making available one or more resources for the event; and
allocating said one or more resources to the event based on criteria associated with the event or said one or more resources.
